(19) United States
(12) Patent Application Publication
(10) Pub. No.: US 2023/0090104 A1
(43) Pub. Date: Mar. 23, 2023

(54) MODULAR STORAGE SYSTEM

(71) Applicant: LIBERTY HARDWARE MFG. CORP., Winston-Salem, NC (US)

(72) Inventors: Tara BROWN, High Point, NC (US); Robert Douglas HEGARTY, Winston-Salem, NC (US); James Allen AUSTIN, III, High Point, NC (US); Michael WITT, Kernersville, NC (US); Jeffrey John MATHISON, Chicago, IL (US); Gabriel PRERO, Chicago, IL (US); Patrick William BOEHNEN, Summerfield, NC (US); Brittany McCULLERS, Winston-Salem, NC (US); James PRUITT, Winston-Salem, NC (US)

(21) Appl. No.: 17/478,078

(22) Filed: Sep. 17, 2021

(51) Int. Cl. A47B 87/00; A47F 5/10; G09F 23/10; G09F 23/06

(52) U.S. Cl. CPC A47B 87/00; A47F 5/10; G09F 23/10; G09F 23/06; A47B 88/00

(57) ABSTRACT

A modular storage system is provided with a plurality of upright side supports to be supported upon an underlying support surface. Each of the plurality of upright side supports is packaged separately. A plurality of horizontal cross members is provided to interconnect a pair of upright side supports. The plurality of horizontal cross members is packaged separately from the plurality of upright side supports.

### TECHNICAL FIELD

Various embodiments relate to modular storage systems.

### BACKGROUND

The prior art has provided modular storage systems to permit a customer to purchase kitted assemblies to be assembled as a customized storage system.

### SUMMARY

According to an embodiment, a modular storage system is provided with a plurality of upright side supports to be supported upon an underlying support surface. Each of the plurality of upright side supports is packaged separately. A plurality of horizontal cross members is provided to interconnect a pair of upright side supports. The plurality of horizontal cross members is packaged separately from the plurality of upright side supports.

According to a further embodiment, each of the upright side supports is further defined as an upright side support assembly with a pair of elongate vertical rails, and at least one horizontal rail interconnecting the pair of elongate vertical rails in a depth direction of the storage system.

According to an even further embodiment, each of the pair of elongate vertical rails is formed with elongate grooves formed along a length.

According to another further embodiment, the plurality of horizontal cross members is sized to interconnect the pair of upright side supports in a length direction of the storage system.

According to another further embodiment, the plurality of horizontal cross members is further provided with a first plurality of horizontal cross members sized to interconnect the pair of upright side supports in a length direction of the storage system. The first plurality of horizontal cross members is formed with a first length to provide storage units of the first length. A second plurality of horizontal cross members is sized to interconnect the pair of upright side supports in the length direction of the storage system. The second plurality of horizontal cross members is formed with a second length that is different than the first length to provide storage units of the second length.

According to an even further embodiment, the first plurality of horizontal cross members is separately packaged as first horizontal cross member kits. The second plurality of horizontal cross members is separately packaged as second horizontal cross member kits.

According to another further embodiment, a first plurality of shelving assemblies is sized to be supported upon the pair of upright side supports in the length direction of the storage system. The first plurality of shelving assemblies is formed with the first length to provide shelves of the first length. A second plurality of shelving assemblies is sized to be supported upon the pair of upright side supports in the length direction of the storage system. The second plurality of shelving assemblies is formed with the second length to provide shelves of the second length.

According to an even further embodiment, the first plurality of shelving assemblies is separately packaged as first shelving kits. The second plurality of shelving assemblies is separately packaged as second shelving kits.

According to another further embodiment, a first plurality of hanger rod assemblies is sized to be supported upon the pair of upright side supports in the length direction of the storage system. The first plurality of hanger rod assemblies is formed with the first length to provide hanger rods of the first length. A second plurality of hanger rod assemblies is sized to be supported upon the pair of upright side supports in the length direction of the storage system. The second plurality of hanger rod assemblies is formed with the second length to provide hanger rods of the second length.

According to an even further embodiment, the first plurality of hanger rod assemblies is separately packaged as first hanger rod kits. The second plurality of hanger rod assemblies is separately packaged as second hanger rod kits.

According to another further embodiment, a first plurality of drawer assemblies is sized to be supported upon the pair of upright side supports in the length direction of the storage system. The first plurality of drawer assemblies is formed with a first width to provide drawers of the first width. A second plurality of drawer assemblies is sized to be supported upon the pair of upright side supports in the length direction of the storage system. The second plurality of drawer assemblies is formed with a second width to provide drawers of the second width.

According to an even further embodiment, the first plurality of drawer assemblies is separately packaged as first drawer kits. The second plurality of drawer assemblies is separately packaged as second drawer kits.

According to another further embodiment, instructive indicia illustrate a method for selecting the plurality of upright side supports and the plurality of horizontal cross members for the storage system.

According to an even further embodiment, the instructive indicia illustrate a method for selecting accessories for the storage system.

According to another further embodiment, a book with separate adjacent panels illustrates various storage system options for collectively illustrating various storage system combinations.

According to another embodiment, a retail display unit is provided with an array of a plurality of upright side supports to be supported upon an underlying support surface. Each of the plurality of upright side supports is packaged separately. An array of a plurality of horizontal cross members is provided to interconnect a pair of upright side supports. The plurality of horizontal cross members is packaged separately from the plurality of upright side supports.

According to a further embodiment, the array of the plurality of horizontal cross members is further defined as a first array of a first plurality of horizontal cross members with a first length. The retail display is further provided with a second array of a second plurality of horizontal cross members to interconnect a pair of upright side supports. The second plurality of horizontal cross members is packaged separately from the plurality of upright side supports and the first plurality of horizontal cross members.

According to another embodiment, a method for customizing a storage system determines an overall storage system length. A quantity of storage units within the storage system is determined. A quantity of upright side support kits is selected that is greater than the quantity of storage units by one. A quantity of horizontal cross member kits is selected that is the same quantity of the quantity of storage units.

According to another embodiment, a method for customizing a storage system determines an overall storage system length. A length of storage units within the storage system is determined. A quantity of storage units with the storage system is determined. A plurality of upright side support kits is selected. A plurality of horizontal cross member kits is selected of the length of the determined storage unit length.

According to a further embodiment, a plurality of accessories is selected of the length of the determined storage unit length.

### BRIEF DESCRIPTION OF THE DRAWINGS

FIG. 1 is a front perspective view of a retail display unit according to an embodiment;

FIG. 2 is an exploded front perspective view of a modular storage assembly of the retail display unit of FIG. 1, according to an embodiment;

FIG. 3 is an enlarged front elevation view of a portion of the retail display unit of FIG. 1;

FIG. 4 is a schematic view of instructional indicia of the retail display unit of FIG. 1;

FIG. 5 is a schematic view of instructional indicia of the retail display unit of FIG. 1;

FIG. 6 is a schematic view of instructional indicia according to another embodiment;

FIG. 7 is a schematic view of the instructional indicia of FIG. 6, illustrating a subsequent step;

FIG. 8 is a schematic view of the instructional indicia of FIG. 6, illustrating a subsequent step;

FIG. 9 is a front elevation view of instructional indicia according to another embodiment; and

FIG. 10 is a front perspective view of the instructional indicia of FIG. 9.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Prior art storage systems are merchandised as complete all-in-one kits containing pre-selected components. Prior art storage systems are also merchandised as individual components that must be selected by the consumer.

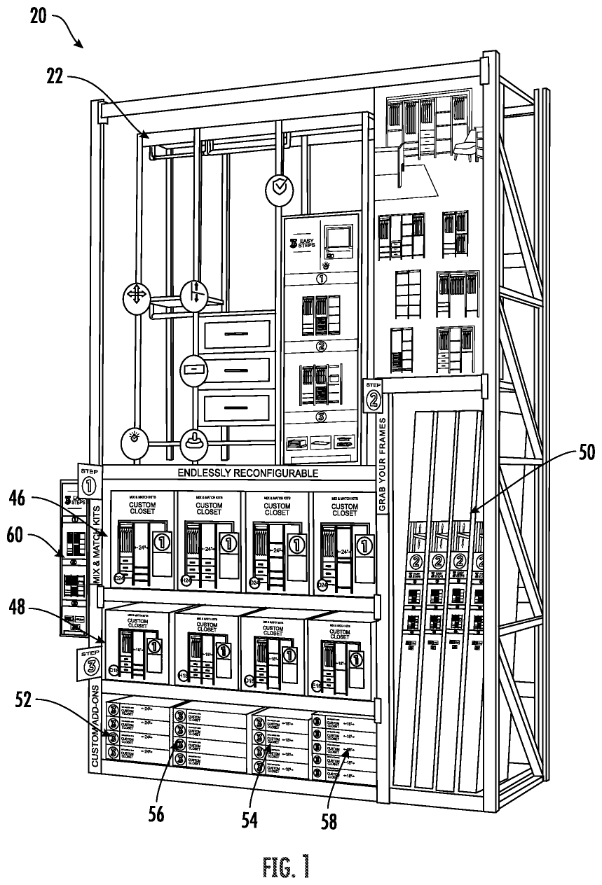

Referring now to FIG. 1, a retail storage display system 20 is illustrated according to an embodiment. The display system 20 is sized to be displayed within a retail store aisle, such as a home improvement store. The display system 20 is utilized for both displaying and retailing storage system components. The display system 20 may also include a sample storage system 22 to illustrate an example of an assembled system 22. FIG. 1 illustrates the modular closet storage system 22 according to an embodiment, with three units or towers. The storage system 22 is depicted a frame and various accessories. The modular closet storage system 22 is repeatable, modular, and adjustable to provide various sizes, arrangements, and configurations to the end user.

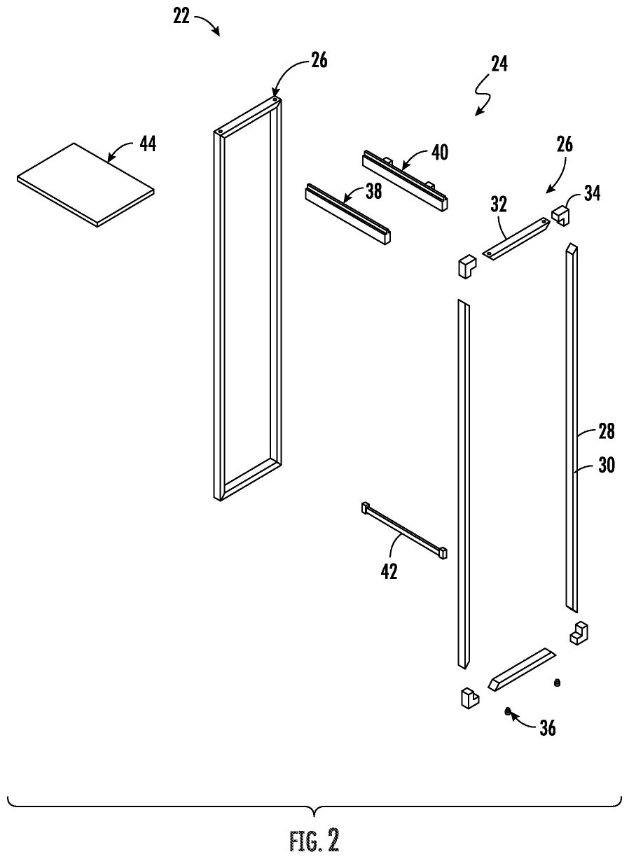

FIG. 2 illustrates a single tower 24 of the modular storage system 22 with many of the accessories removed. The modular storage system 22 is illustrated and described in further detail in Hegarty et al., United States Patent Application Publication No. US 2021/0093082 A1, which published to Liberty Hardware Mfg., on Apr. 1, 2021, the disclosure of which is incorporated in its entirety by reference herein. The single tower 24 provides a frame for one unit of the modular storage system 22. The single tower 24 includes a pair of upright side support assemblies 26 to be supported upon an underlying support surface, such as a floor. Each of the pair of upright side support assemblies 26 includes a pair of elongate vertical rails 28. The vertical rails 28 may each be formed from a hollow aluminum extrusion. The vertical rails 28 may also each be identical for interchangeability, and simplification of the assembly process. The vertical rails 28 are also each formed with grooves 30 with a series of incrementally spaced apart slots formed within the grooves 30 for mounting hardware at various locations.

The side support assemblies 26 also include a pair of shorter horizontal rails 32 or cross members. The horizontal rails 32 are also formed from extruded aluminum with a similar profile to the vertical rails 28. The horizontal rails 32 are each interchangeable for ease in assembly. The vertical rails 28 and the horizontal rails 32 are mitered to be assembled together. Upon assembly, the horizontal rails 32 extend in a depth direction of the storage system 22.

The side support assemblies 26 may also include a plurality of corner connectors 34 that are sized to be inserted into the hollow mitered ends of the vertical rails 28 and the horizontal rails 32 to interconnect the side support assemblies 26. The corner connectors 34 may be formed from a polymeric material, such as nylon. A plurality of fasteners may also be provided to fasten the corner connectors 34 into each of the rails 28, 32. The side support assemblies 26 may each include a plurality of levelers 36 to contact the underlying support surface to be manually adjusted to level the single tower 24. The levelers 36 may fasten directly into the corner connectors 34.

The single tower 24 includes a plurality of horizontal crossbars 38, 40, 42 interconnecting the side support assemblies 26, which are provided by a top front crossbar 38, a top rear crossbar 40, and a lower crossbar 42. Each of the crossbars 38, 40, 42 are cross members that extend in a length direction of the storage system 22. The single tower 24 may also include a shelf 44, which is supported by the pairs of side support assemblies 26 and the top crossbars 38, 40.

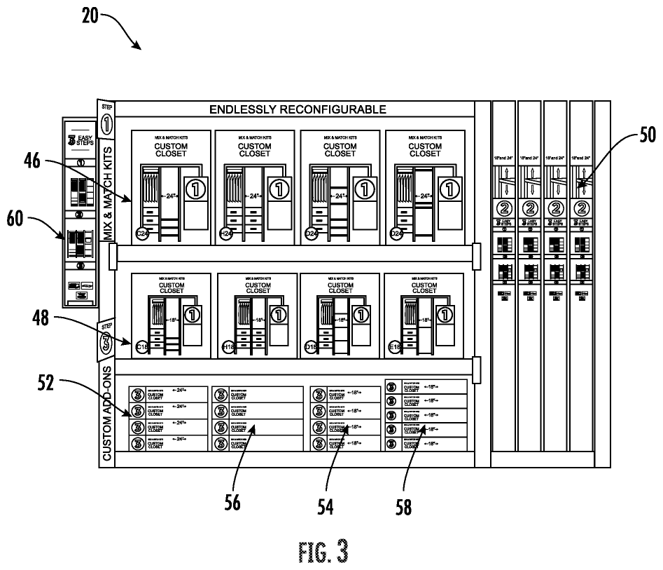

FIGS. 1 and 3 illustrate that the display system 20 displays the components of the storage system 22 in various separately packaged kits. The frames of the storage system 22 are packaged separately as kits. For example, the display system 20 includes an array of kits 46 of frame components. Each kit 46 includes a plurality of horizontal crossbars 38, 40, 42 for connecting a pair of side support assemblies 26 together.

The storage system 22 may offer varying tower lengths. For example, the side support assemblies 26 may be spaced horizontally based on the lengths of the crossbars 38, 40, 42. A second array of kits 48 is also provided in the display system 20. Each of the kits 48 also includes a plurality of horizontal crossbars 38, 40, 42. However, the second array of kits 48 offer crossbars 38, 40, 42 of a different length than the first array of kits 46 to permit towers with different lengths. According to one example, the first array of kits 46 include crossbars 38, 40, 42 for a twenty-four inch spacing of the side support assemblies 26; and the second array of kits 48 include crossbars 38, 40, 42 for an eighteen inch spacing. Various tower lengths and various tower length options may be employed. Each tower 24 may employ a common height and a common depth to permit combining of adjacent towers of varying lengths.

The display system 20 also offers an array of kits 50, which each include a side support assembly 26. The side support assemblies 26 are packaged in kits 50, separate from the separately packaged horizontal crossbar kits 46, 48 to permit the consumer to configure and arrange the storage system 22. The crossbar kits 46, 48 can be provided with crossbars 38, 40, 42 only. The kits 46, 48 can also be provided with various combinations of accessories. For example, the kits 46, 48 can each include the crossbars 38, 40, 42 with accessories such as shelves, clothing rods, drawers, shelving and clothes rod combination, drawers and clothing rod combination, and the like.

The display system 20 may also include arrays of accessory kits without crossbars 38, 40, 42 for customization and to increase a number of accessories within the towers. A first array of drawer kits 52 is provided in the display system 20. The first array of drawer kits 52 have the first length for cooperation with towers that utilize the crossbars 38, 40, 42 of the array of the first kits 46. A second array of drawer kits 54 is also provided, with the second length for addition to towers 24 that employ crossbars 38, 40, 42 from the second kits 48. Likewise, a first array of shelf kits 56 is provided with the first length for addition to towers 24 with the crossbars 38, 40, 42 from the first kits 46. A second array of shelf kits 58 is displayed, with shelves having the second length for installation in the towers 24 with the crossbars 38, 40, 42 from the second kits 48.

By packaging the accessories 46, 48, 52, 54, 56, 58 for each section of the modular closet system 22 separately from the side support assembly kits 50, the accessories 46, 48, 52, 54, 56, 58 can be mixed and matched. In addition, the structural frame of the storage system 22 is sold in individual upright support assembly kits 50 of the frame. The modular components 46, 48, 50, 52, 54, 56, 58 of the closet system 22 are packaged separately as frame kits 50, frame and accessory kits 46, 48, and accessory kits 52, 54, 56, 58.

The display system 20 includes signage 60 to illustrate a process for selecting the components 46, 48, 50, 52, 54, 56, 58 for the storage system 22. The signage 60 includes instructional indicia 62 for illustrating the process. The instructional indicia 62 may also be provided on the packaging of the kits 46, 48, 50, 52, 54, 56, 58, on an online website, on a kiosk, and the like.

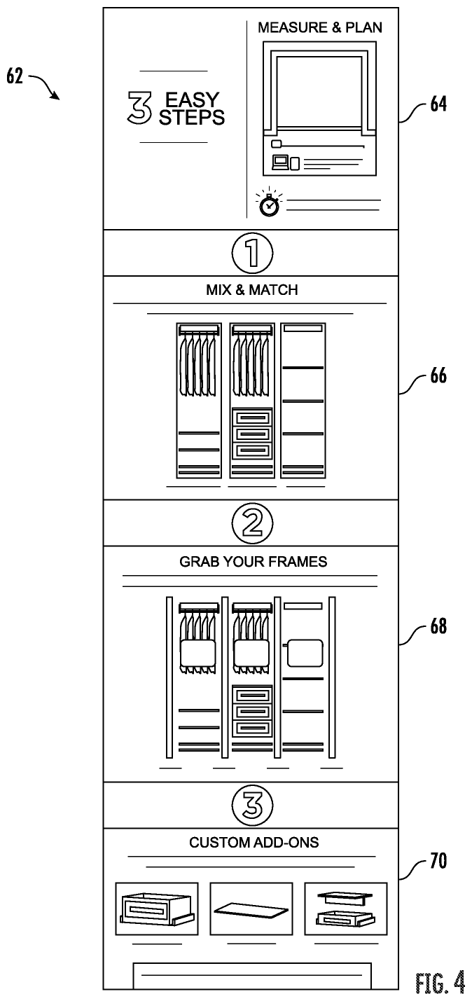

FIG. 4 illustrates an embodiment of the instructional indicia 62. As a preliminary step 64, the consumer measures a target installation location, such as a closet to determine an available space for the storage system 22. With these measurements, the consumer determines an overall length available for the storage system 22. The consumer then determines a total quantity of towers 24 or units within the storage system 22, and the lengths for the towers 24 at step 66. The consumer may select lengths of one size or combinations of various lengths. The consumer selects the lengths and quantities of towers 24 to fit within the available length. The consumer also determines at step 66, which styles of towers 24 are desired. Then at step 66, the user selects the kits 46, 48 associated with the selected tower lengths and options. Step 66 is labeled as step one on the instructional indicia 62. Likewise, the kits 46, 48 may also be labeled as step one to coordinate the selections of kits 46, 48.

At step 68, the consumer selects a quantity of side support kits 50. The quantity of side supports kits 50 is one more than the quantity of towers 24. Since adjacent towers 24 share an intermediate side support assembly 26, side support assemblies 26 are not abutted between the towers 24. The quantity of side support kits 50 exceeds the quantity of horizontal cross member kits 46, 48 by one in order to close both terminal ends of the storage system 22. Step 68 is labeled as step two on the instructional indicia 62. The side support kits 50 are also labeled as step two to coordinate the consumer selection of the physical kits 50.

Step 70 of the instructional indicia 62 illustrates a step for adding to additional drawer or shelving kits 52, 54, 56, 58 to the storage system 22. The user determines the quantity and size of additional accessory kits 52, 54, 56, 58, and selects the kits 52, 54, 56, 58 from the display system 20. The accessory step 70 is labeled as step three. Likewise, the accessory kits 52, 54, 56, 58 that do not include frame crossbars 38, 40, 42 are also labeled as step three to assist the consumer in selecting the kits 52, 54, 56, 58 for the desired customization. Although the steps 66, 68, 70 and the associated kits 46, 48, 50, 52, 54, 56, 58 are numbered steps one to three, any number or sequence of steps may be employed with the display system 20 for the storage system 22.

FIG. 5 illustrates instructional indicia 72, which can be provided on another side of the signage 60, on the display system 20, on the packaged kits 46, 48, 50, 52, 54, 56, 58, or the like. The instructional indicia 72 depicts example storage systems 22 for various lengths to assist a consumer in selecting a customized storage system 22.

The modular nature of the storage system 22 allows the system 22 to be merchandised using smaller kits 46, 48, 50, 52, 54, 56, 58 than the prior art that contain a subset of components to build a customized storage system 22. This design modularity allows for a balance between a flexibility of selecting individual components and a simplicity of buying a single all-in-one storage system.

The storage system 22 in the display system 20 provides many advantages over the prior art. The components of the system 22 can be packed with maximum density, taking less shelf space at retail and less vehicle space to transport than existing solutions. The separation of certain components allows for flexibility and increased efficiency in manufacturing. The contents of the frame kits 50 can be manufactured in different locations from the contents of the accessory kits 52, 54, 56, 58 and shipped separately to the retailer. With the modular storage system 22, the retailer is not required to stock all-in-one kits that contain many redundant parts. This flexibility frees up additional shelf space for more consumer options. The consumer has much more choice in their purchase compared to the prior art since kits 46, 48, 50, 52, 54, 56, 58 can be mixed and matched for endlessly configurable variations. The components are still provided in kits 46, 48, 50, 52, 54, 56, 58 so that specialized software or retail staff are not required to assist the customer in selecting and configuring individual components.

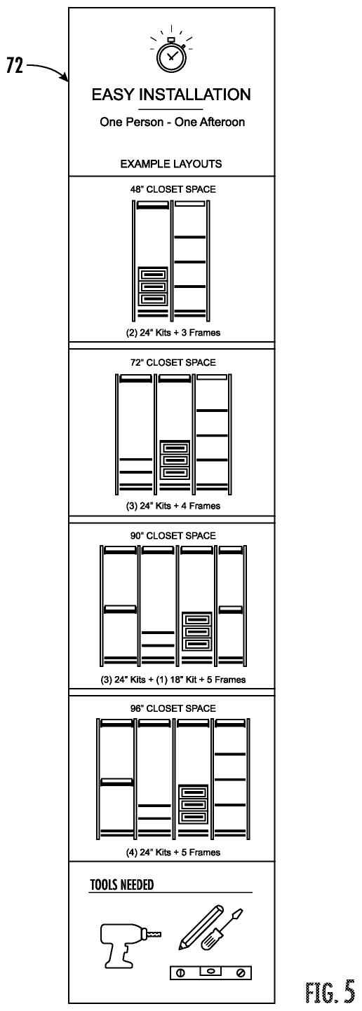

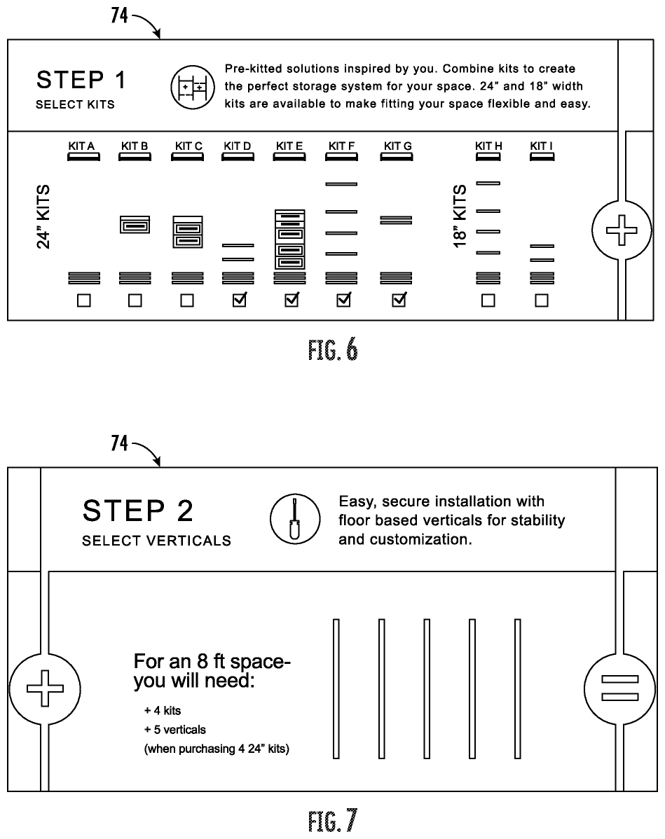

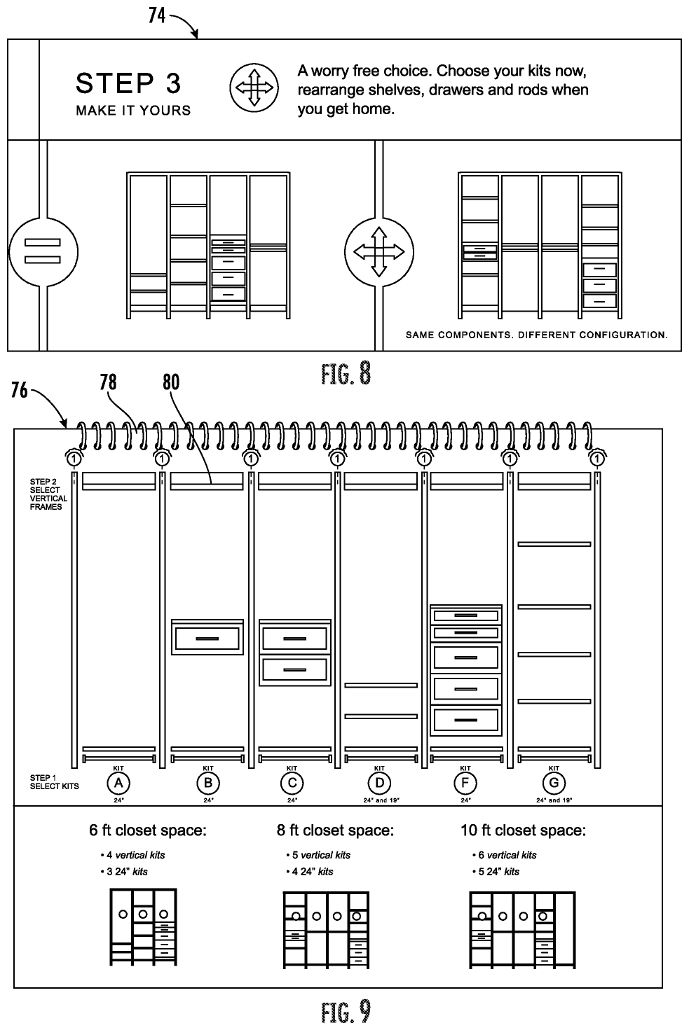

FIGS. 6-8 illustrate instructional indicia 74 for a display system of a modular storage system according to another embodiment. In FIG. 6, the consumer selects from a plurality of kit options and sizes. In FIG. 7, the consumer selects the number of verticals, or side support assemblies required for the storage system. The quantity of verticals is one greater than a quantity of kits selected in FIG. 6. In FIG. 8, the consumer installs, assembles and customizes the storage system.

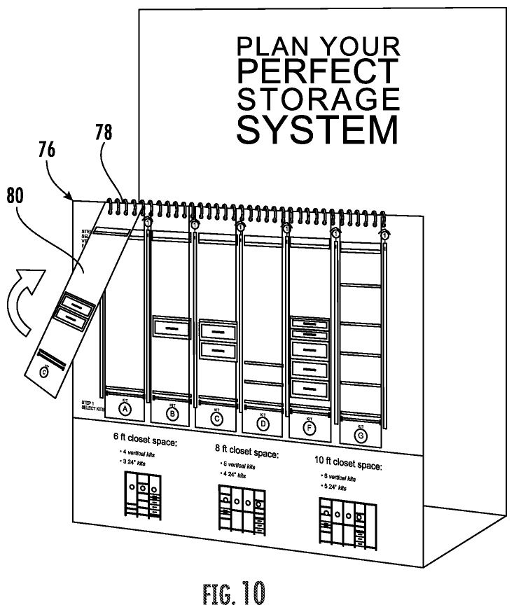

FIGS. 9 and 10 illustrate instructional indicia for designing a storage system embodied in a flip book 76. The flip book 76 includes a hinge 78, which may be a wire helix, or the like. A plurality of panels 80 are pivotally connected to the hinge 78. Each panel 80 includes an example of a tower option of the storage system. Each panel 80 may correspond to one of the kits of FIG. 6. The panels 80 may also include various arrangements for each kit. The panels 80 can be collectively arranged to illustrate various storage system combinations. The flip book 76 can assist a consumer to layout and design a storage system. The flip book 76 can also assist the consumer to select the appropriate kits from the display system.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A modular storage system comprising:
a plurality of upright side supports to be supported upon an underlying support surface, each of the plurality of upright side supports packaged separately; and
a plurality of horizontal cross members to interconnect a pair of upright side supports, the plurality of horizontal cross members packaged separately from the plurality of upright side supports.

2. The storage system of claim 1 wherein each of the upright side supports is further defined as an upright side support assembly comprising:
a pair of elongate vertical rails; and
at least one horizontal rail interconnecting the pair of elongate vertical rails in a depth direction of the storage system.

3. The storage system of claim 2 wherein each of the pair of elongate vertical rails is formed with elongate grooves formed along a length.

4. The storage system of claim 1 wherein the plurality of horizontal cross members is sized to interconnect the pair of upright side supports in a length direction of the storage system.

5. The storage system of claim 1 wherein the plurality of horizontal cross members further comprises:
a first plurality of horizontal cross members sized to interconnect the pair of upright side supports in a length direction of the storage system, the first plurality of horizontal cross members being formed with a first length to provide storage units of the first length; and
a second plurality of horizontal cross members sized to interconnect the pair of upright side supports in the length direction of the storage system, the second plurality of horizontal cross members being formed with a second length that is different than the first length to provide storage units of the second length.

6. The storage system of claim 5 wherein the first plurality of horizontal cross members is separately packaged as first horizontal cross member kits; and
wherein the second plurality of horizontal cross members is separately packaged as second horizontal cross member kits.

7. The storage system of claim 5 further comprising:
a first plurality of shelving assemblies sized to be supported upon the pair of upright side supports in the length direction of the storage system, the first plurality of shelving assemblies being formed with the first length to provide shelves of the first length; and
a second plurality of shelving assemblies sized to be supported upon the pair of upright side supports in the length direction of the storage system, the second plurality of shelving assemblies being formed with the second length to provide shelves of the second length.

8. The storage system of claim 7 wherein the first plurality of shelving assemblies is separately packaged as first shelving kits; and
wherein the second plurality of shelving assemblies is separately packaged as second shelving kits.

9. The storage system of claim 5 further comprising:
a first plurality of hanger rod assemblies sized to be supported upon the pair of upright side supports in the length direction of the storage system, the first plurality of hanger rod assemblies being formed with the first length to provide hanger rods of the first length; and
a second plurality of hanger rod assemblies sized to be supported upon the pair of upright side supports in the length direction of the storage system, the second plurality of hanger rod assemblies being formed with the second length to provide hanger rods of the second length.

10. The storage system of claim 9 wherein the first plurality of hanger rod assemblies is separately packaged as first hanger rod kits; and
wherein the second plurality of hanger rod assemblies is separately packaged as second hanger rod kits.

11. The storage system of claim 5 further comprising:
a first plurality of drawer assemblies sized to be supported upon the pair of upright side supports in the length direction of the storage system, the first plurality of drawer assemblies being formed with a first width to provide drawers of the first width; and
a second plurality of drawer assemblies sized to be supported upon the pair of upright side supports in the length direction of the storage system, the second plurality of drawer assemblies being formed with a second width to provide drawers of the second width.

12. The storage system of claim 11 wherein the first plurality of drawer assemblies is separately packaged as first drawer kits; and
wherein the second plurality of drawer assemblies is separately packaged as second drawer kits.

13. The storage system of claim 1 further comprising instructive indicia to illustrate a method for selecting the plurality of upright side supports and the plurality of horizontal cross members for the storage system.

14. The storage system of claim 13 wherein the instructive indicia illustrate a method for selecting accessories for the storage system.

15. The storage system of claim 1 further comprising a book with separate adjacent panels illustrating various storage system options for collectively illustrating various storage system combinations.

16. A retail display unit comprising:
an array of the plurality of upright side supports of claim 1; and
an array of the plurality of horizontal cross members.

17. The retail display unit of claim 16 wherein the array of the plurality of horizontal cross members is further defined as a first array of a first plurality of horizontal cross members with a first length; and
wherein the retail display further comprises a second array of a second plurality of horizontal cross members to interconnect a pair of upright side supports, the second plurality of horizontal cross members packaged separately from the plurality of upright side supports and the first plurality of horizontal cross members.

18. A method for customizing a storage system comprising:
determining an overall storage system length;
determining a quantity of storage units within the storage system;
selecting a quantity of upright side support kits that is greater than the quantity of storage units by one; and
selecting a quantity of horizontal cross member kits that is the same quantity of the quantity of storage units.

19. A method for customizing a storage system comprising:
determining an overall storage system length;
determining a length of storage units within the storage system;
determining a quantity of storage units with the storage system;
selecting a plurality of upright side support kits; and
selecting a plurality of horizontal cross member kits of the length of the determined storage unit length.

20. The method of claim 19 further comprising selecting a plurality of accessories of the length of the determined storage unit length.
